(19) United States
(12) Patent Application Publication
(10) Pub. No.: US 2007/0051366 A1
(43) Pub. Date: Mar. 8, 2007

(54) MEDICAL DEVICES WITH GERM-REDUCING SURFACES

(75) Inventors: Hans-Ullrich HANSMANN, Barnitz (DE); Gotz KULLIK, Lubeck (DE); Henryk SCHNAARS, Lubeck (DE); Claus BUNKE, Sereetz (DE); Erich SIEGEL, Bad Schwartau (DE)

Correspondence Address: MCGLEW & TUTTLE, PC, P.O. BOX 9227, SCARBOROUGH STATION, SCARBOROUGH, NY, 10510-9227, US

(73) Assignee: DRAGER MEDICAL AG & CO. KG, Lubeck (DE)

(21) Appl. No.: 11/420,347

(22) Filed: May 25, 2006

(30) Foreign Application Priority Data
Sep. 7, 2005 (DE) 10 2005 042 372.8

(51) Int. Cl. A62B 9/04

(52) U.S. Cl. 128/202.27

(57) ABSTRACT

Silver particles with a size of 1 nm to 500 nm is provided in a matrix material that is used as a surface coating on medical devices or breathing masks for reducing the germ count on same.

### CROSS REFERENCE TO RELATED APPLICATIONS

This application claims the benefit of priority under 35 U.S.C. § 119 of German Patent Application DE 10 2005 042 372.8 filed Sep. 7, 2005, the entire contents of which are incorporated herein by reference.

### FIELD OF THE INVENTION

The present invention pertains to medical devices, especially respirators (ventilators) and/or anesthesia apparatuses. The present invention also pertains to breathing masks.

### BACKGROUND OF THE INVENTION

The components of a respirator, which are in contact with the fresh gas for the patient, are not subject to contamination with bacteria, fungi and viruses in case of proper handling. However, contamination cannot be ruled out in case of improper handling, and bacteria, fungi and viruses can spread rapidly under the conditions prevailing there. This problem is even more acute for components of an anesthesia apparatus with a breathing gas return. A humid and warm climate, which is ideal for the growth of bacteria and fungi, prevails within the respiration system and the flexible tubes leading to the patient. Regular cleaning and hygiene measures are correspondingly usually specified for these devices. The goal of performing the disinfection procedures performed is to reduce the germ count, e.g., by a certain factor of live microorganisms. However, experience has shown that these cleaning and hygienic measures are not always implemented reliably. Bacteria and/or fungi that are still present can spread again even if a medical device that was disinfected correctly in this respect is not being used.

Handling components of respirators and anesthesia apparatuses, such as breathing bags, alarm and control buttons, are not in contact with the gas being supplied for the patient. However, the surfaces may be contaminated by the operating personnel and contamination can thus be transmitted externally to the patient via this pathway. The same problems arise as in the case of the disinfection of breathing gas-carrying components.

Seals and filter materials of breathing masks become damp due to the close contact with the skin and likewise offer an ideal climate for the growth of bacteria and fungi. Regular cleaning and hygiene measures are usually provided for these devices as well, but there is no guarantee that they are always complied with.

Therefore, it can never be ruled out with certainty that infections can originate from the medical devices or breathing masks for the patient or user even if they are cleaned and disinfected according to the regulations.

An additional protection of medical devices or breathing masks against contamination with bacteria, fungi and/or viruses is therefore desirable.

WO 00/09173 discloses the use of stabilized silver ions as a surface coating of medical devices. The silver ions are stabilized by complexing with primary, secondary or tertiary amines, and are bound to hydrophilic polymers.

### SUMMARY OF THE INVENTION

The object of the present invention is to provide improved protection for medical devices or breathing masks against contamination of the surfaces with bacteria, fungi and/or viruses.

According to the invention, a medical device or a breathing mask is provided having a surface made of a matrix material that contains silver particles with a size of 1 nm to 500 nm.

It was surprisingly found that improved protection of the medical devices or breathing masks against contamination with bacteria, fungi and/or viruses can be achieved by the use of silver particles in the nanosize range of 1 nm to 500 nm compared to the use of stabilized silver ions. It is suspected that silver ions (Ag⁺), which are responsible for the antimicrobial action, are formed on the surface of the silver particles. If the silver particles are larger than 500 nm, the surface of the silver particles is too small to offer an effective antimicrobial protection. The smaller the silver particles are, the more they tend to agglomerate, which leads to a further decrease of the surface. The silver particles therefore preferably have a size of 5 nm to 100 nm and especially 10 nm to 80 nm.

The silver particles are present in the matrix material preferably at a concentration of 1 ppm to 1,000 ppm, more preferably 100 ppm to 800 ppm and especially 250 ppm to 750 ppm, and most preferably 500 pm to 700 ppm relative to the total weight of the matrix material.

The matrix material is preferably a polymer, preferably a hydrophilic polymer. It is suspected that hydrophilic polymers facilitate the formation of ions on the surface of the silver particles and the ion transport to the surface of the matrix material. Polyphenylene sulfide (PPS), polysulfone (PSU), polyphenylene sulfone (PPSU), cycloolefin copolymers (COC), silicones, polyoxyalkylenes, such as polyoxymethylene, and polyamides (PA), such as polyamide-12 (PA-12) or polyamide-6, which optionally contain up to 35 wt. % of glass fibers or glass beads, are most preferred. Polyphenylene sulfide most preferably contains up to 30 wt. % of glass fibers or glass beads. Polyamide most preferably contains up to 25 wt. % of glass fibers or glass beads.

The surface material may contain, furthermore, an inorganic filler, which further facilitates the formation of ions. This is especially advantageous if the matrix material is not sufficiently hydrophilic. The inorganic filler is preferably selected from among zeolites, silicon dioxide, titanium dioxide, aluminum oxide, zirconium oxide and mixtures thereof.

The medical device is preferably a respirator or anesthesia apparatus. The surface of the respirator or anesthesia apparatus is preferably that of a flexible breathing gas tube, a socket, bushing or seal in the respiration system of the respirator and/or anesthesia apparatus, that of a sensor housing and/or flexible tube for the internal measured gas return, that of a Y-piece for the breathing air tube, that of a control element for manual adjustment and/or that of a manual breathing bag, lime container, cable and/or tube duct, and other surfaces may also have the matrix material containing silver particles according to the present invention.

Silver particles with a mean particle size of 1 nm to 500 nm are commercially available, for example, from the firm of rent-a-scientist GmbH, Regensburg, under the name AgPURE Nanosilver®.

The silver particles can be introduced into the matrix material in the usual manner by mixing in a suitable mixer. However, a premix of the silver particles with a wax, which is subsequently mixed with the matrix material, is preferably prepared first. The premix may contain, for example, 1 wt. % to 10 wt. % of silver particles.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic side view showing an anesthetic evaporator according to the invention which can be connected to respirators or anesthesia apparatuses;

FIG. 2A is a schematic top view of a handwheel of the anesthetic evaporator of FIG. 1;

FIG. 2B is a schematic side view of a handwheel of the anesthetic evaporator of FIG. 1; and

FIG. 3 is schematic view of a respiration system of an anesthesia apparatus according to the invention.

### DESCRIPTION OF THE PREFERRED EMBODIMENTS

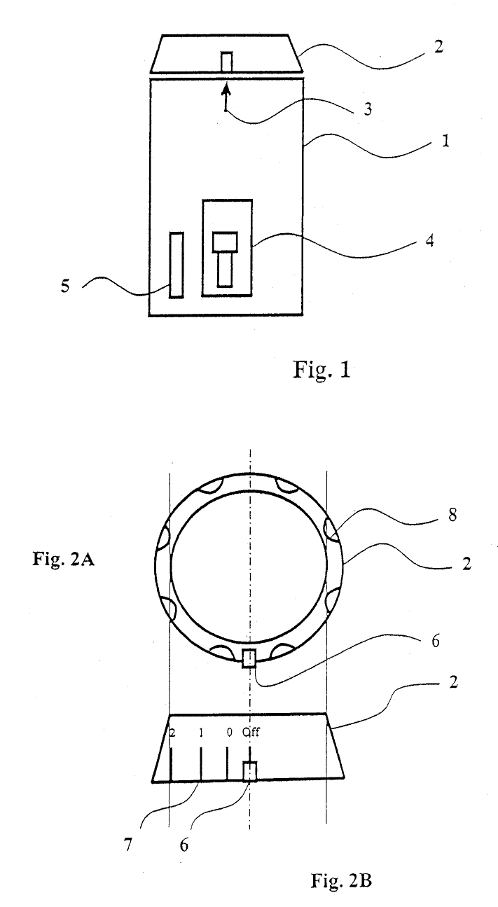

Referring to the drawings in particular, FIG. 1 shows an anesthetic evaporator 1, which can be connected to respirators or anesthesia apparatuses.

The anesthetic evaporator has a handwheel 2 for manually setting the quantity of anesthetic to be dispensed, a setting mark 3 for optically checking the state of opening of the anesthetic evaporator 1, a filling device 4 and an inspection glass 5.

FIGS. 2A and 2B show the handwheel 2 of the anesthetic evaporator 1 in a schematic top view and a schematic side view. The top view shows the profiling 8 as well as a switch 6 for locking and unlocking the handwheel 2. The schematic side view shows, furthermore, setting marks 7.

In the course of a usual anesthesia, the concentrations of the anesthetic in the breathing gas mixture are set differently. A high anesthetic concentration is usually selected during the initiation of the anesthesia, whereas a medium concentration of the anesthetic is set during the further course. The concentration of the anesthetic in the breathing air mixture is further reduced near the end of the anesthesia. To set the anesthetic gas concentration, the anesthesiologist must actuate the handwheel 2 of the anesthetic evaporator 1. Besides, the anesthesiologist must be in contact with the patient. Transmission of germs from the handwheel to the patient and vice versa is now possible. Due to the coating of the handwheel with polyamide-6, which contained 25 wt. % of glass fibers and 680 ppm of silver particles with an average size of about 10 nm, reduced growth of bacteria and fungi, and death of contaminating germs applied previously was observed.

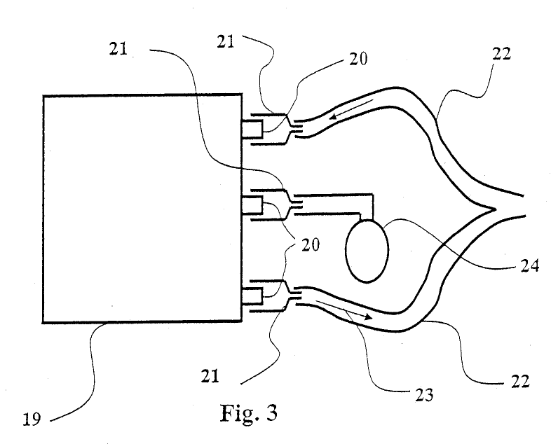

FIG. 3 shows a respiration system 19 of an anesthesia apparatus.

The respiration system 19 comprises connections 20 and sockets 21 for the flexible tubes 22, with which the anesthetic gas 23 is transported to and from the patient. Furthermore, a breathing bag 24 is shown. The anesthetic gas 23 is sent from the respiration system 19 through the flexible tube 22 to the patient (not shown) and subsequently from the patient back into the respiration system 19. A very humid climate, usually having a temperature of 30° C. to 35° C., prevails within the sockets 21, which connect the respiration system 19 and the flexible tubes 22. The coating of the inner surfaces of the sockets 21 and/or of the inner sides of the flexible breathing gas tubes 22 with polyphenylene sulfide (PPS), which contains 680 ppm of silver particles with an average size of about 10 nm, led to markedly reduced growth of bacteria or fungal populations.

While specific embodiments of the invention have been shown and described in detail to illustrate the application of the principles of the invention, it will be understood that the invention may be embodied otherwise without departing from such principles.

What is claimed is:

1. A medical device, comprising a surface made of a matrix material that contains silver particles with a size of 1 nm to 500 nm.

2. A medical device in accordance with claim 1, wherein the silver particles have a size of 5 nm to 100 nm.

3. A medical device in accordance with claim 2, wherein the silver particles have a size of 10 nm to 80 nm.

4. A medical device in accordance with claim 1, wherein the matrix material comprises a polymer.

5. A medical device in accordance with claim 4, wherein the polymer is a hydrophilic polymer.

6. A medical device in accordance with claim 5, wherein the hydrophilic polymer is selected from the group comprising polyphenylene sulfide (PPS), polysulfone (PSU), polyphenylene sulfone (PPSU), polyoxyalkylene, polyamide (PA), cycloolefin copolymers (COC), and silicones.

7. A medical device in accordance with claim 6, wherein the polyoxyalkylene is polyoxymethylene (POM).

8. A medical device in accordance with claim 6, wherein the polyamide is selected from the group comprising polyamide-12 (PA-12) and polyamide-6 (PA-6).

9. A medical device in accordance with claim 1, wherein the surface material further comprises an inorganic filler.

10. A medical device in accordance with claim 9, wherein the inorganic filler is selected from the group comprising zeolite, silicon dioxide, titanium dioxide, aluminum oxide and zirconium oxide.

11. A medical device in accordance with claim 1, wherein the silver particles are present in the matrix material at a concentration of 1 ppm to 1,000 ppm relative to the total weight of the matrix material.

12. A medical device in accordance with claim 11, wherein the silver particles are present in the matrix material at a concentration of 250 ppm to 750 ppm relative to the total weight of the matrix material.

13. A medical device in accordance with claim 1, wherein said surface is a surface of a respirator component or an anesthesia apparatus component.

14. A medical device in accordance with claim 13, wherein the surface is a surface of a flexible breathing gas tube, of a socket, of a bushing or seal in the respiration system of the respirator and/or anesthesia apparatus, that of a sensor housing and/or flexible tube for the internal measured gas return, that of a Y-piece for the flexible breathing air tube, that of a control element for manual adjustment and/or that of a manual breathing bag, lime container, cable and/or tube duct.

15. A breathing mask comprising a surface made of a material matrix that contains silver particles of a size of 1 nm to 500 nm.

16. A process comprising:
providing a component or part with a surface having a mixture of silver particles with a size of 1 nm to 500 nm and with a matrix material.

17. A process according to claim 16, wherein the surface is provided as a coating.

18. A process according to claim 16, wherein the component or part is a medical device component or part or a breathing mask component or part.

19. A process according to claim 18, wherein the medical device component or part or a breathing mask component is exposed to a patient or medical operator or the environment of the patient or medical operator during use.
